(19) United States
(12) Patent Application Publication
(10) Pub. No.: US 2013/0302773 A1
(43) Pub. Date: Nov. 14, 2013

(54) SELF-CONCEPT IMPLICIT ASSOCIATION TEST

(71) Applicants: Dario Cvencek, Seattle, WA (US); Anthony G. Greenwald, Seattle, WA (US); Andrew N. Meltzoff, Seattle, WA (US)

(72) Inventors: Dario Cvencek, Seattle, WA (US); Anthony G. Greenwald, Seattle, WA (US); Andrew N. Meltzoff, Seattle, WA (US)

(73) Assignee: University of Washington Through it's Center for Commercialization, Seattle, WA (US)

(21) Appl. No.: 13/976,555

(22) PCT Filed: Jan. 17, 2012
(86) PCT No.: PCT/US12/21492

§ 371 Date: Jul. 31, 2013

Related U.S. Application Data
(60) Provisional application No. 61/432,986, filed on Jan. 14, 2011.

(51) Int. Cl. G09B 7/02

(52) U.S. Cl. CPC G09B 7/02
USPC 434/335

(57) ABSTRACT

The methods and systems described herein enable the administration of Implicit Association Tests (IATs) without the use of “self-concept” or “self-report.” An example method involves a computing system providing a visual indication of categories including (i) a user-associated-objects category (ii) a user-unassociated-objects category, (iii) a positivevalence-objects category, and (iv) a negative-valence-objects category. The categories are grouped into a first group and a second group. The computing system provides an indication of a stimulus. The stimulus may be associated with at least one of the categories. The computing system may then receive input data indicating a correct classification of the stimulus with one of the first group and the second group. Ultimately, the computing system determines an amount of time elapsed between providing the indication of the stimulus and receiving the input data indicating the correct classification of the stimulus with one of the first group and the second group.

### RELATED APPLICATIONS

This application claims priority to U.S. Provisional Patent Application Ser. No. 61/432,986 filed Jan. 14, 2011, entitled Methods and Systems for Developing and Administering Implicit Tests of Association for Measuring Self-Esteem and Other Constructs, which is incorporated herein in its entirety.

### STATEMENT OF U.S. GOVERNMENT INTEREST

This invention was made with government support under SBE-0354453 awarded by the National Science Foundation. The government has certain rights in the invention.

### FIELD OF THE INVENTION

The present invention relates generally to psychological testing and, in particular, to methods and systems for the administration of Self-Concept Implicit Association Tests (IATs) without the use of “self-report.”

### COPYRIGHT NOTICE

Contained herein is material that is subject to copyright protection. The copyright owner has no objection to the reproduction of the patent disclosure by any person as it appears in the Patent and Trademark Office patent files or records, but otherwise reserves all rights to the copyright whatsoever.

### BACKGROUND

Implicit-association tests (IATs), first described in a 1998 publication (IAT; Greenwald, McGhee, & Schwartz, 1998) were developed to test the strength of a test subject's mental associations between concepts and ideas, based on the test subjects' performance on tests during which test subjects classify various stimuli into different categories or groups. In some arrangements, an IAT may be proctored via a computing system in which the stimuli are presented on a graphical display and the subject classifies the stimuli using manual input via a keyboard or other input device.

While IATs have proven effective in evaluating strengths of association between various concepts and categories held by reasonably well-educated, literate, non-disabled adults, the standard IAT format has proven difficult or impossible to administer to various other categories of test subjects, including young children, illiterate adults, people with various types of disabilities, and others. Recently, techniques have been developed to administer IATs to some such groups. Nonetheless, administrators and developers of IATs still desire improved techniques for the administration of IATs to, and development of IATs for, various categories of test subjects.

### SUMMARY

Implicit measures of attitudes based on response-latency techniques, such as the Implicit Association Test (IAT), are already routinely used in research with adults. However, cognitive demands of certain IAT testing techniques prevent their use with young children or other test subjects with relatively low levels of cognitive development.

More particularly, IATs generally involve the use of stimuli (such as abstract linguistic pronouns) associated with the “self” which requires that the test subject understand that the stimuli does, in fact, correspond to his or her “self.” The methods and systems described herein, however, may enable the administration of Self-Concept IATs without the use of “self-report” or abstract linguistic pronouns to represent the concept of “self”

In one example embodiment, a system is provided. The system may include: (1) a processor; (2) a physical computer readable medium; and (3) program instructions stored on the physical computer readable medium and executable by the processor to: (a) provide a visual indication of categories including (i) a user-associated-objects category (ii) a user-unassociated-objects category, (iii) a positive-valence-objects category, and (iv) a negative-valence-objects category, where the categories are grouped into a first group and a second group, where the first group is one of (i) the user-associated-objects category and the positive-valence-objects category and (ii) the user-associated-objects category and the negative-valence-objects category, and where the second group is one of (i) the user-unassociated-objects category and the positive-valence-objects category, and (ii) the user-unassociated-objects category and the negative-valence-objects category; (b) provide an indication of a stimulus, the stimulus associated with at least one of (i) the user-associated-objects category, (ii) the user-unassociated-objects category, (iii) the positive-valence-objects category, and (iv) the negative-valence-objects category; (c) receive input data indicating a correct classification of the stimulus with one of the first group and the second group; and (d) determine an amount of time elapsed between providing the indication of the stimulus and receiving the input data indicating the correct classification of the stimulus with one of the first group and the second group.

In a further aspect, a physical computer-readable medium is provided. The physical computer-readable medium may include instructions including: (a) instructions for providing a visual indication of categories including (i) a user-associated-objects category (ii) a user-unassociated-objects category, (iii) a positive-valence-objects category, and (iv) a negative-valence-objects category, where the categories are grouped into a first group and a second group, where the first group is one of (i) the user-associated-objects category and the positive-valence-objects category and (ii) the user-associated-objects category and the negative-valence-objects category, and where the second group is one of (i) the user-unassociated-objects category and the positive-valence-objects category, and (ii) the user-unassociated-objects category and the negative-valence-objects category; (b) instructions for providing an indication of a stimulus, the stimulus associated with at least one of (i) the user-associated-objects category, (ii) the user-unassociated-objects category, (iii) the positive-valence-objects category, and (iv) the negative-valence-objects category; (c) instructions for receiving input data indicating a correct classification of the stimulus with one of the first group and the second group; and (d) instructions for determining an amount of time elapsed between providing the indication of the stimulus and receiving the input data indicating a correct classification of the stimulus with one of the first group and the second group.

In yet a further aspect, a method is provided. The method may involve: (a) providing a visual indication of categories including (i) a user-associated-objects category (ii) a user-unassociated-objects category, (iii) a positive-valence-objects category, and (iv) a negative-valence-objects category, where the categories are grouped into a first group and a second group, where the first group is one of (i) the user-associated-objects category and the positive-valence-objects category and (ii) the user-associated-objects category and the negative-valence-objects category, and where the second group is one of (i) the user-unassociated-objects category and the positive-valence-objects category, and (ii) the user-unassociated-objects category and the negative-valence-objects category; (b) providing an indication of a stimulus, the stimulus associated with at least one of (i) the user-associated-objects category, (ii) the user-unassociated-objects category, (iii) the positive-valence-objects category, and (iv) the negative-valence-objects category; (c) receiving input data indicating a correct classification of the stimulus with one of the first group and the second group; and (d) determining an amount of time elapsed between providing the indication of the stimulus and receiving the input data indicating a correct classification of the stimulus with one of the first group and the second group.

These as well as other aspects, advantages, and alternatives, will become apparent to those of ordinary skill in the art by reading the following detailed description, with reference where appropriate to the accompanying drawings.

### BRIEF DESCRIPTION OF THE FIGURES

FIG. 1 shows a simplified block diagram of an example communication network in which the present method can be implemented.

FIG. 2A shows a simplified block diagram of a network-access device arranged to implement aspects of at least one embodiment of the method.

FIG. 2B shows a simplified block diagram of a server arranged to implement aspects of at least one embodiment of the method.

FIG. 3 shows a flowchart depicting functions that can be carried out in accordance with at least one embodiment of the method.

FIG. 4A shows example user-associated objects in accordance with at least one embodiment of the method.

FIG. 4B shows example user-unassociated objects in accordance with at least one embodiment of the method.

FIGS. 5A-8B show an example testing arrangement in accordance with at least one embodiment of the method.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that aspects of the present disclosure, as generally described herein, and illustrated in the figures, can be arranged, substituted, combined, separated, and/or designed in a wide variety of different configurations, all of which are explicitly contemplated herein.

### 1. OVERVIEW

The term implicit has been used to refer to measurement methods that (a) do not require introspective access, (b) reduce the amount of available mental control to produce the response, and/or (c) reduce the role of intentional processes. Implicit attitudes, as measured by an Implicit Association Test (IAT), are thought of as links that connect a group category (e.g., male or female) to a valence category (e.g., good or bad). The IAT provides an implicit measure of attitudes by comparing response speeds in a double-categorization task that combines a concept classification (e.g., boy vs. girl) and an attribute classification (e.g., good vs. bad), with either or both categories. For example, if a participant is significantly faster when girl and good share a response button than when boy and good do, she can be said to have an implicit attitude that links “girls” rather than “boys” with a positive valence of “good.”

IATs are often administered via the use of a computing system, though this is not necessary as discussed further below in Section 4. Thus, although certain aspects of the disclosure herein are described as carried out via a computing system, such description is for the purpose of example and explanation only, and should not be taken to be limiting.

An IAT administered via a computing system, such as a personal computer, workstation, or other suitable computing device, often involves a computing system that includes at least a graphical display and an input device. The graphical display may provide visual indications of stimuli that elicit test-subject responses. Test subjects may respond to stimuli by depressing particular keys of a keyboard.

During initial phases of IAT administration, a subject may be instructed to depress a first button when stimuli related to a first group of categories are presented to the subject and to depress a second button when stimuli related to a second group of categories are presented. During such an initial phase, the subject may be provided with practice stimulus/response interactions to facilitate learning the group/response-button combinations.

During a testing phase of an IAT, the test subject may be instructed to depress the appropriate key in response to presentation of a stimulus, generally a stimulus that clearly belongs to one of the categories within the two groups. At the instant at which the stimulus is presented, the computing system may initialize a timer. The user, in response to perceiving the stimulus, may depress the response button that indicates a categorization of the stimulus into one of the two groups (i.e., the correct group). At the instant the button is depressed, the elapsed time between presentation of the stimulus and the response (or response latency) may be determined by the computing system.

Generally, an IAT may involve at least two blocks, each block in turn involving a number of stimulus-presentation/test-subject-response pairs, or tasks. During the first block, the group/response-button combinations may remain constant. Then, the relationship between the buttons and the groups and/or categories presented to the subject may be changed.

In general, a subject is required to provide a correct answer to each displayed stimulus. When the response is incorrect, the mistake may be indicated to the subject, and the subject may be required to input the correct response. In general, response latencies for initially incorrect responses are therefore greater in value than latencies for correct responses, due to the need to input a second, correct response following an initially incorrect response.

Response times in differing blocks are used to implicitly assess a subject's degree of associations between categories. There are a variety of ways to compute meaningful scores, some of which are discussed in U.S. patent application Ser. No. 13/252,908, which is incorporated herein in its entirety.

Note that self-esteem is an attitude towards one's self. Further, while the example provided above generally involves connecting a group category (e.g., male or female) to a valence category (e.g., good or bad), it is also possible to connect other group categories (e.g., you or I) to a valence category. Thus, it is possible to use the above-described IAT to provide a measure of one's self esteem, or attitude towards one's self.

IATs have many significant advantages over more traditional types of psychological tests that require subjects to provide information responses to questions. In many cases, a test subject may intentionally or inadvertently respond insincerely to particular types of questions, as a result of conscious or unconscious feelings, prejudices, and/or a sense of the test-takers expectations. The IAT, by contrast, measures response time for the test subject's response to presented stimuli. When the responses require choosing input buttons associated with given groups, subjects generally require less time to respond to displayed stimuli than when the input keys are associated with clashing, or discordant concepts. Because the subject is encouraged to respond quickly and mechanically to the stimuli, response times tend to be far less influenced by subjects' expectations, assumptions, prejudices, and other factors that may lead to less useful results obtained in standard psychological tests.

The present disclosure includes a description of techniques for administration of IATs to test subjects without the need for “self-report” or abstract linguistic pronouns to represent the concept of “self.” To do so, novel (e.g., gender- and race-neutral) objects are used for representing me and not-me. For example, a subject may be given a first collection of novel objects and told such objects are theirs. The subject may additionally be given a second collection of novel objects and told such objects are not theirs. Thus, stimuli representing me novel objects and the not-me novel objects, may be used to indirectly assess the subject's association of me to valence (positive or negative). In this way, the IAT may be administered to the subject without the subject necessarily being capable of identifying the concept of “self.”

### 2. EXAMPLE ARCHITECTURE

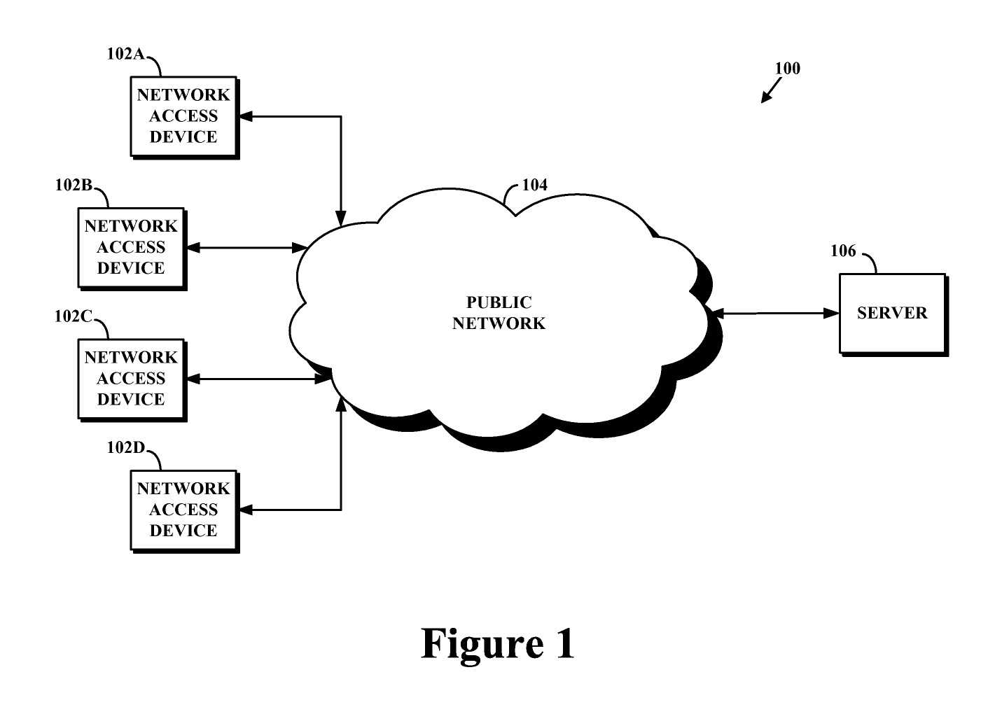

As noted above, IATs are often administered via the use of a computing system. FIG. 1 shows a simplified block diagram of an example communication network in which the present method can be implemented. It should be understood that this and other arrangements described herein are set forth only as examples. Those skilled in the art will appreciate that other arrangements and elements (e.g., machines, interfaces, functions, orders, and groupings of functions, etc.) can be used instead and that some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. And various functions described herein may be carried out by a processor executing instructions stored in memory.

As shown in FIG. 1, example network 100 includes various network-access devices 102A-102D, public network 104 such as the Internet, and server 106. Note that additional entities not depicted in FIG. 1 could be present as well. As an example, there could be more network-access devices and more servers in communication with public network 104. Other network elements may be in communication with public network 104 as well. Also, there could be one or more devices and/or networks making up at least part of one or more of the communication links depicted in FIG. 1. As an example, there could be one or more routers, switches, or other devices or networks on the communication links between network-access devices 102A-102D, public network 104, and/or server 106.

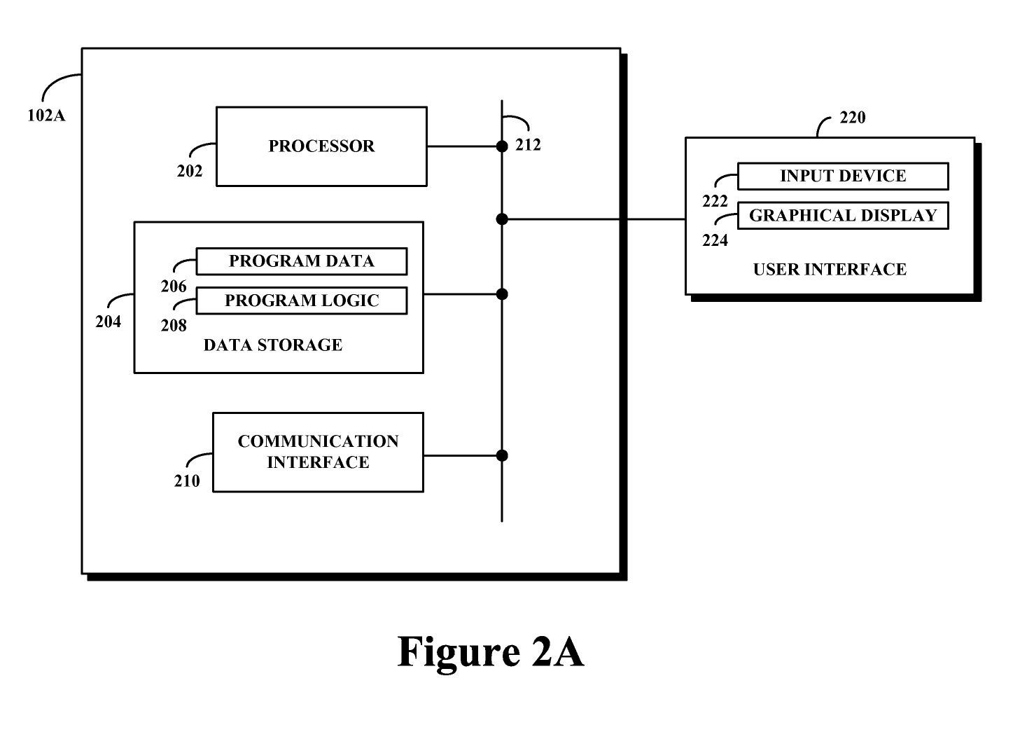

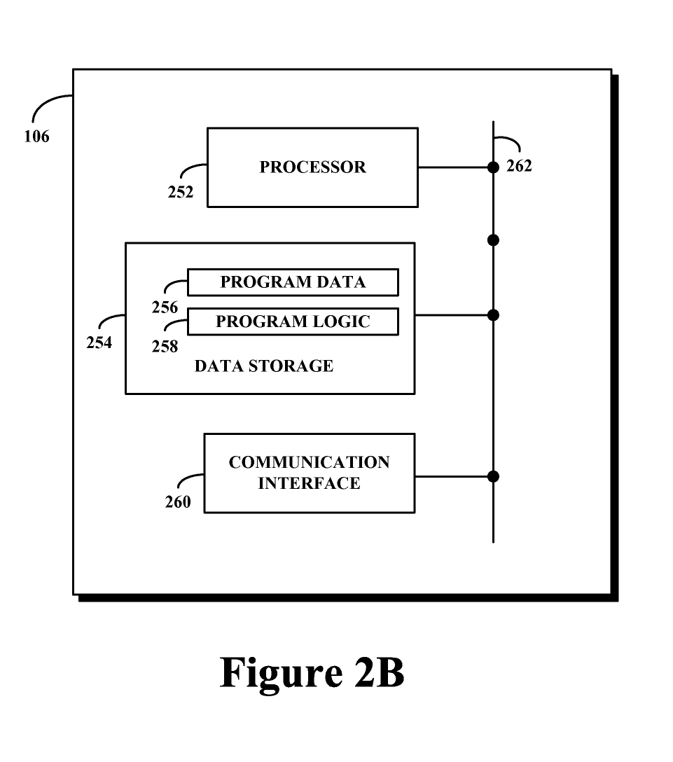

Each of network-access devices 102A-102D may be any network-access device arranged to carry out the network-access device functions described herein. As such each of network-access devices 102A-102D, including network-access device 102A as shown in FIG. 2A, may include processor 202, data storage 204, and communication interface 210, all linked together via system bus, network, or other connection mechanism 212.

Processor 202 may comprise one or more general purpose microprocessors and/or one or more dedicated signal processors and may be integrated in whole or in part with communication interface 210. Data storage 204 may comprise memory and/or other storage components, such as optical, magnetic, organic or other memory disc storage, which can be volatile and/or non-volatile, internal and/or external, and integrated in whole or in part with processor 202. Data storage 204 may be arranged to contain (i) program data 206 and (ii) program logic 208. Although these components are described herein as separate data storage elements, the elements could just as well be physically integrated together or distributed in various other ways. For example, program data 206 may be maintained in data storage 204 separate from program logic 208, for easy updating and reference by program logic 208.

Communication interface 210 typically functions to communicatively couple network-access device 102A to networks, such as public network 104. As such, communication interface 210 may include a wired (e.g., Ethernet) and/or wireless (e.g., Wi-Fi) packet-data interface, for communicating with other devices, entities, and/or networks. Network-access device 102A may also include multiple interfaces 210, such as one through which network-access device 102A sends communication, and one through which network-access device 102A receives communication.

Network-access device 102A may also include, or may be otherwise communicatively coupled to, user interface 220. User interface 220 may include input device 222 comprising, for example, buttons, a touch screen, a microphone, and/or any other elements for receiving inputs. User interface 220 may also include one or more elements for communicating outputs, for example, one or more graphical displays 224 and/or a speaker. In operation, user interface 220 may be configured to display a graphical user interface (GUI) via graphical display 224 and may also be configured to receive inputs, via input device 222, corresponding to use of such a GUI. In some embodiments, input device 222 may include a visual-capture device such as a camera. The camera may be configured and/or arranged to track eye movements.

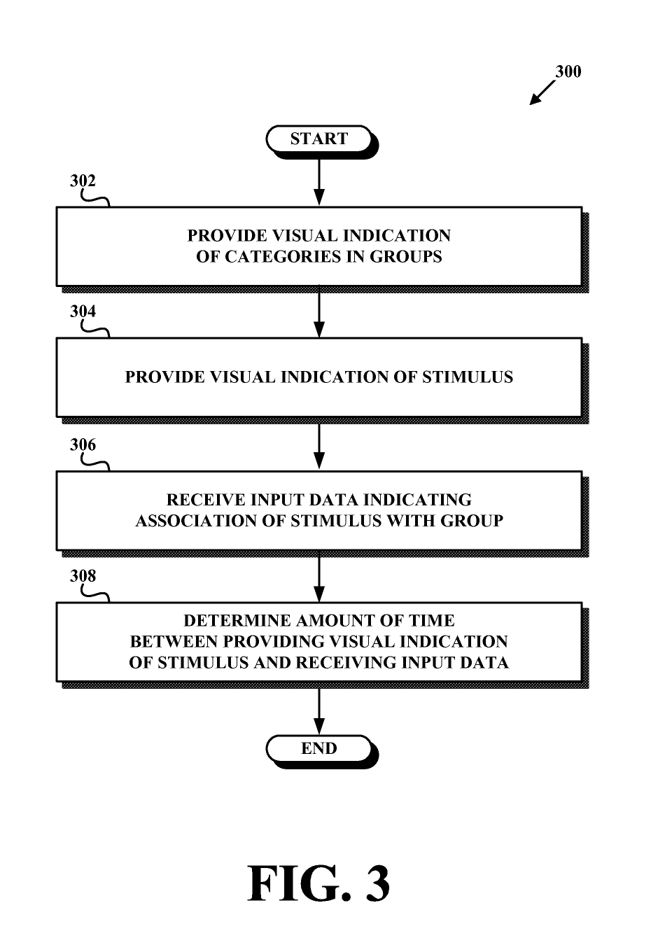

Server 106 may be any network server or other computing system arranged to carry out the server functions described herein including, but not limited to, those functions described with respect to FIG. 3. As such, as shown in FIG. 2B, server 106 may include processor 252, data storage 254 comprising program data 256 and program logic 258, and communication interface 260, all linked together via system bus, network, or other connection mechanism 262. Processor 252, data storage 254, program data 256, program logic 258, and communication interface 260 may be configured and/or arranged similar to processor 252, data storage 254, program data 256, program logic 258, and communication interface 260, respectively, as described above with respect to network-access device 102A.

Data storage 254 may contain information used by server 106 in operation. For example, date storage 254 may comprise instructions executable by the processor for carrying out the server functions described herein including, but not limited to, those functions described below with respect to FIG. 3. As another example, data storage 254 may contain various design logic and/or design data used for determining a test result, such as the logic and data described below with respect to FIG. 3. Generally, data storage 254 may contain information used by server 106 to provide an e-commerce storefront that is accessible by various network-access devices, such as network-access device 102A, over public network 104.

Returning to FIG. 1, public network 104 may include one or more wide area networks, one or more local area networks, one or more public networks such as the Internet, one or more private networks, one or more wired networks, one or more wireless networks, and/or one or more networks of any other variety. Devices in communication with public network 104 (including, but not limited to, network-access devices 102A-102D and server 106) may exchange data using a packet-switched protocol such as IP, and may be identified by an address such as an IP address.

### 3. EXAMPLE METHOD

FIG. 3 shows a flowchart depicting functions that can be carried out in accordance with at least one embodiment of the method. As shown in FIG. 3 method 300 begins at block 302 with a computing system providing a visual indication of categories including (i) a user-associated-objects category (ii) a user-unassociated-objects category, (iii) a positive-valence-objects category, and (iv) a negative-valence-objects category. The categories may be grouped into a first group and a second group, where the first group is one of (i) the user-associated-objects category and the positive-valence-objects category and (ii) the user-associated-objects category and the negative-valence-objects category, and the second group may be one of (i) the user-unassociated-objects category and the positive-valence-objects category, and (ii) the user-unassociated-objects category and the negative-valence-objects category. At block 304, the computing system provides an indication of a stimulus. The stimulus may be associated with at least one of (i) the user-associated-objects category, (ii) the user-unassociated-objects category, (iii) the positive-valence-objects category, and (iv) the negative-valence-objects category. At block 306, the computing system receives input data indicating a correct classification of the stimulus with one of the first group and the second group. And at block 308, the computing system determines an amount of time elapsed between providing the indication of the stimulus and receiving the input data indicating the correct classification of the stimulus with one of the first group and the second group. These steps are explained in the following subsections.

And although method 300 may be carried out by server 106, this is not required. In some embodiments, method 300 may be carried out entirely, or in part, by network-access device 102A or some other computing system that may or may not be communicatively coupled to any network.

a. Provide Visual Indication of Categories in Groups

At block 302, a computing system provides a visual indication of categories including (i) a user-associated-objects category (ii) a user-unassociated-objects category, (iii) a positive-valence-objects category, and (iv) a negative-valence-objects category. The categories may be grouped into a first group and a second group, where the first group may be one of (i) the user-associated-objects category and the positive-valence-objects category and (ii) the user-associated-objects category and the negative-valence-objects category, and the second group may be one of (i) the user-unassociated-objects category and the positive-valence-objects category, and (ii) the user-unassociated-objects category and the negative-valence-objects category.

The objects in the user-associated-objects category and the user-unassociated-objects category may be substantially novel objects. By “substantially novel” it is generally meant that the objects are generally unknown to the test subject and/or that the objects are generally inanimate. The object need not be entirely novel—that is, some aspects of the object may not be novel. For example, the substantially novel object may be a flag containing a unique design—an object-type that may be familiar to the test subject (e.g., the test subject may have knowledge of “flags”), but having a design that is unfamiliar to the test subject. Those of skill in the art will appreciate that generally the more novel an object is, the less preexisting valence association (or bias) a given test subject may exhibit towards (or against) the object.

In an embodiment, the substantially novel objects may be substantially gender-neutral objects. In another embodiment, the substantially novel objects may be substantially race-neutral objects. In yet another embodiment, the substantially novel objects may be substantially gender-neutral objects and substantially race-neutral objects. In general, the novel objects may be neutral along any one or more dimension, such as any social-economic or demographic dimension, that is desired. Such neutrality of the novel object may prohibit, or limit, the introduction of preexisting valence associations (or bias) into the testing arrangement.

Some particular examples of objects that may be used in the user-associated-objects category and the user-unassociated-objects category include flags, cards, chips, tokens, emblems, and clothing. Other examples may exist as well. Generally, the novel objects may be designed in a nondescript manner such that a test subject is unlikely to have any preexisting valence associations (or bias) towards the particular object.

As one even more particular example, the objects may be flags. Flags may be a desirable novel object for use in accordance with the disclosure herein given that “flags” are generally recognized by, and a part of the standard vocabulary of, relatively young children. To increase the likelihood that the flags are viewed as novel by test subjects, it may be desirable to use flags that are not commonly known, or that otherwise do not exist—such as the flags of existing countries, states, teams, or other organizations.

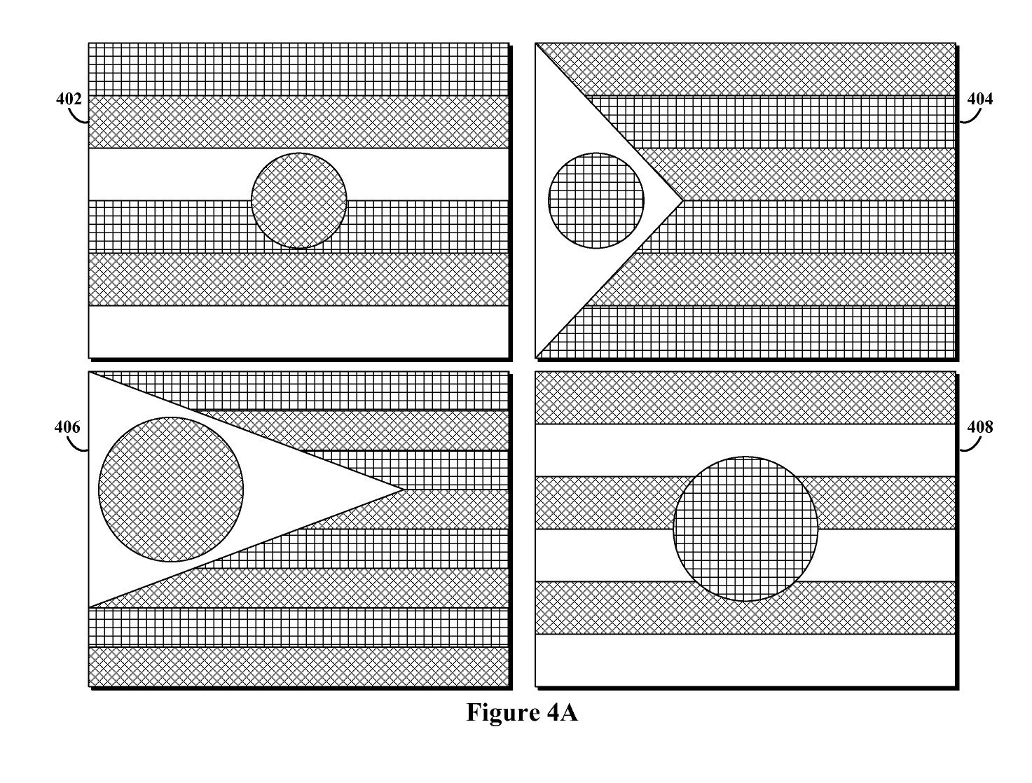

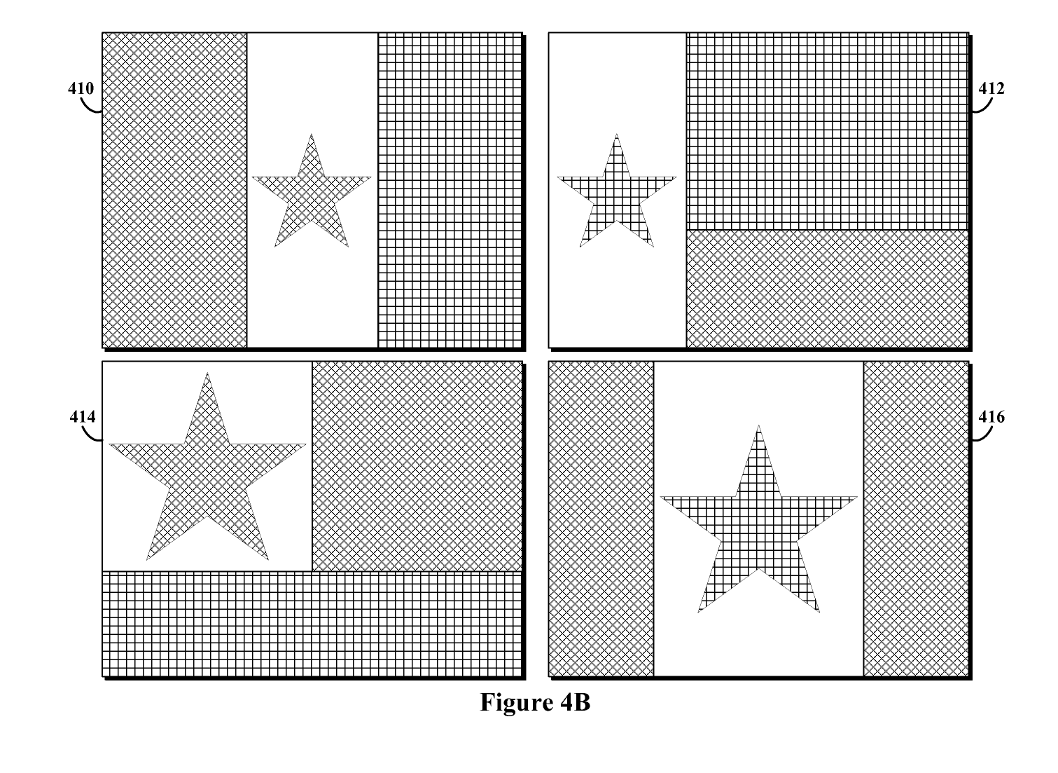

With reference to FIGS. 4A and 4B, for instance, the flags may consist of three colors. In FIGS. 4A and 4B, the plain-white areas may indicate a first color, the vertical-horizontal-hash marks may indicate a second color, and the cross-hash marks may represent a third color.

Generally, it may be desirable to choose opposing colors for the flag colors. Opposing colors generally create maximum contrast and maximum stability and thus are generally most recognizable in combination, especially by individuals who are seeing impaired, such as color-blind individuals. Thus, in an embodiment, one color of the flag may be white, and the other two colors may be opposing colors. More particularly, one color of the flag may be white, the second color of the flag may be blue, and the third color of the flag may be yellow. Further, one color of the flag may be white, the second color of the flag may be red, and the third color of the flag may be green.

Other design elements may be considered beyond color when designing a substantially neutral object such as a flag. Such design elements may be chosen so as to clearly differentiate one category of objects from another category. As one example, primary shapes on the flag may be chosen in a neutral, yet differentiable, manner. As shown, the flags in FIG. 4A include a primary shape of a circle, while the flags in FIG. 4B include a primary shape of a star. As another example, the background design of the flag may be chosen in a neutral, yet differentiable, manner. As shown, the flags in FIG. 4A include a generally striped background, while the flags in FIG. 4B include a generally blocked background

It should be understood that the particular examples of novel objects described above are set forth for purposes of example and explanation only. Many other examples may exist, and therefore the examples described herein should not be taken to be limiting.

As noted above, at block 302, a computing system provides an indication of categories including (i) a user-associated-objects category (ii) a user-unassociated-objects category, (iii) a positive-valence-objects category, and (iv) a negative-valence-objects category.

FIG. 4A shows example objects (i.e., flags) that form a user-associated-objects category. FIG. 4B shows example objects (i.e., flags) that form a user-unassociated-objects category. More particularly, flags 402, 404, 406, and 408 of FIG. 4A (the user-associated flags) have a primary shape of a circle and a background that is general striped. In contrast, flags 410, 412, 414, and 416 of FIG. 4B (the user-unassociated flags) have a primary shape of a star and a background that is generally blocked. Thus, although the user-associated flags and the user-unassociated flags may consist of the same three colors, the flags may be readily distinguished by the test subject given their other design differences. Further, given the common colors of the flags, the potential for user-bias (e.g., a preference for one or the other of the categories of flags based on color) is reduced, if not eliminated.

Positive-valence objects and negative-valence objects may be, generally, represented by spoken words that represent good concepts and bad concepts, respectively. Some particular examples of positive-valence objects (i.e., good concepts) may include the words: fun, happy, nice, and/or good. Thus, the words fun, happy, nice, and good may form a positive-valence-objects category. Some particular examples of negative-valence objects (i.e., bad concepts) may include the words: mean, bad, yucky, and/or mad. Thus, the words mean, bad, yucky, and mad may form a negative-valence-objects category.

It should be understood that the particular examples of neutral-object categories and valence-object categories described above are set forth for purposes of example and explanation only. Many other examples may exist, and therefore the examples described herein should not be taken to be limiting.

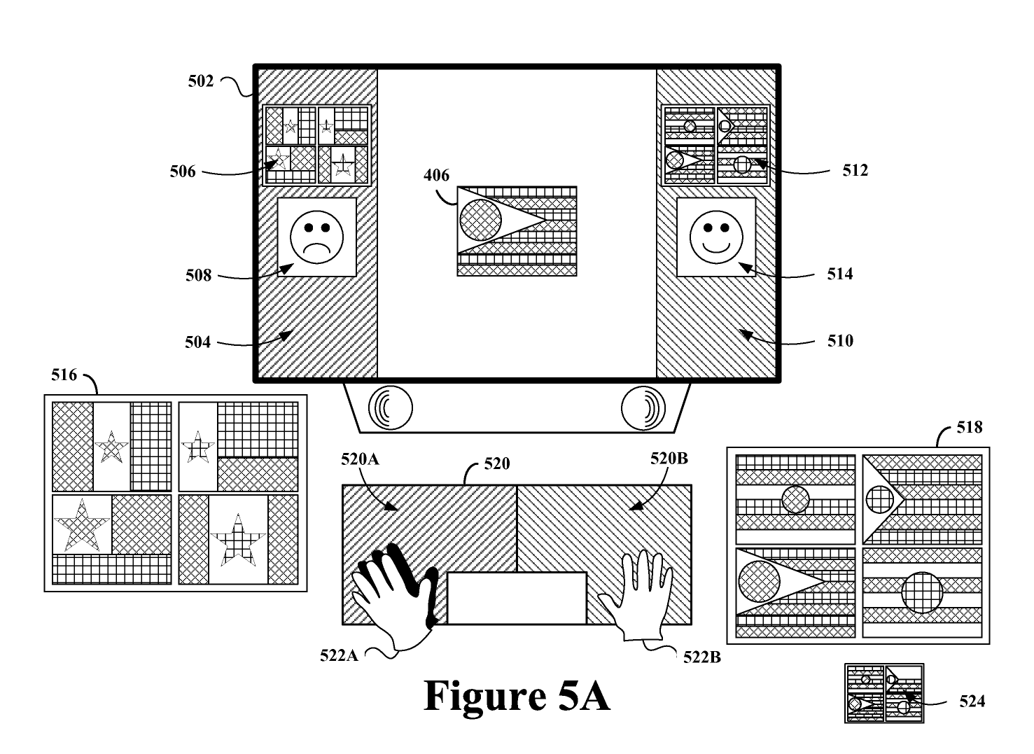

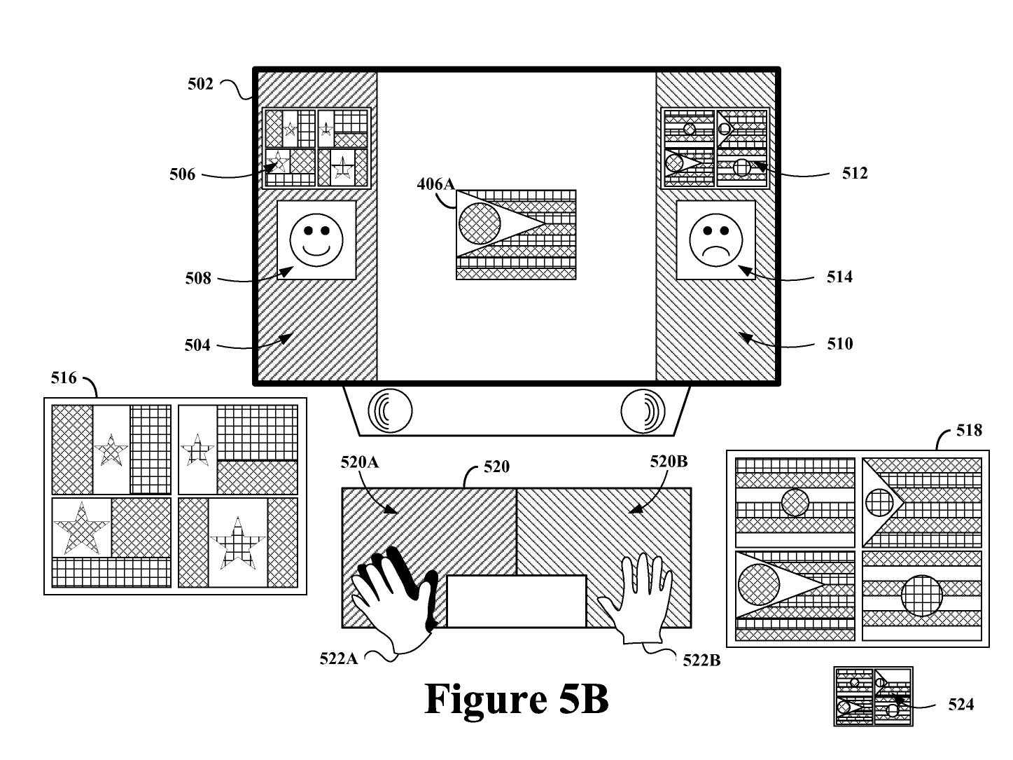

Now, with reference to FIG. 5A, an example testing arrangement 500 is shown. It should be understood that the particular example testing arrangement shown in FIG. 5A is shown for purposes of example and explanation only. Many other arrangements, including additional or alternative items, devices, and/or objects, may exist, and therefore the example shown herein should not be taken to be limiting.

Testing arrangement 500 includes graphical display 502. Graphical display 502 may be communicatively coupled to a computing system that is arranged to carry out functions described herein, including those functions described with respect to FIG. 3. Graphical display 502 may include a second group 504, including a second neutral-object category 506 and a second valence-object category 508 (note that the term “second” in this case is used only in distinction with a “first” group and categories described below). In the example shown in FIG. 5A, second neutral-object category 506 includes flags 410, 412, 414, and 416 of FIG. 4B (the user-unassociated flags), and second valence-object category 508 includes negative-valence objects (i.e., bad concepts) represented by a sad face.

Graphical display 502 may also include a first group 510, including a first neutral-object category 512 and a first valence-object category 514. In the example shown in FIG. 5A, first neutral-object category 512 includes flags 402, 404, 406, and 408 of FIG. 4A (the user-associated flags), and first valence-object category 514 includes positive-valence objects (i.e., good concepts) represented by a happy face.

Testing arrangement 500 also includes a physical representation of each of the user-associated objects and the user-unassociated objects, as shown by physical-user-unassociated objects 516 and physical-user-associated objects 518, respectively. The physical objects may take any suitable form. In the case of flags, for instance, the physical flags may be either attached to flag poles, or lay flat either individually or on collective matting. The physical objects may be given to the test subject to help establish which neutral objects are “theirs” —i.e., which neutral objects are user-associated objects and which neutral objects are user-unassociated objects. The physical objects may be given to the test subject also for the purposes of continually reinforcing with the test subject which objects are “theirs.”

Accordingly, in use, physical-user-unassociated objects 516 may be placed relatively closer to the graphical display (and further from the test subject), and physical-user-associated objects 518 may be placed relatively closer to the test subject (and further from the graphical display). In this way a sense of “ownership” of the user-associated objects 518, as opposed to the user-unassociated objects 516, may be further reinforced with the test subject. Further to this end, the test subject may also be given take-home objects 524 that represent the user-associated objects. Doing so may even further reinforce “ownership” of the user-associated objects 518. The take-home objects 524 may be displayed to the test subject throughout the testing process as a further reminder of which objects are “theirs.” Take-home objects 524 may include stickers having pictures of the user-associated objects, a smaller version of the user-associated objects, or any other easily transportable objects that represent the user-associated objects.

Testing arrangement 500 also includes an input device, such as keyboard 520. In an embodiment, the keyboard may be a keyboard that contains two primary input buttons such as buttons 520A and 520B. Keyboard 520 may be a standard computer keyboard that has been modified so as to include primary input buttons 520A and 520B. In an alternative embodiment, input buttons 520A and 520B may be any desired keys on a standard keyboard.

Generally, each of input buttons 520A and 520B may be associated with one of second group 504 and first group 510. In the example shown in FIG. 5A, button 520A is associated with second group 504 and button 520B is associated with first group 510. In an embodiment, the buttons may be designed so as to represent the respective groups with which they are associated. For instance, button 520A may be the same color as the background of second group 504 (as represented by forward hashes). And button 520B may be the same color as the background of first group 510 (as represented by backward hashes).

It should be noted that the particular categories and groupings of objects shown in FIG. 5A are shown for example only and that various other categories and groupings may be implemented in a testing arrangement as well. Accordingly, as noted above, the categories of objects may be grouped into a first group and a second group, where the first group is one of (i) the user-associated-objects category and the positive-valence-objects category (such as group 504 in FIG. 5A) and (ii) the user-associated-objects category and the negative-valence-objects category, and the second group may be one of (i) the user-unassociated-objects category and the positive-valence-objects category, and (ii) the user-unassociated-objects category and the negative-valence-objects category (such as group 510 in FIG. 5A).

b. Provide Indication of Stimulus

At block 304, the computing system provides an indication of a stimulus. The stimulus may be associated with at least one of (i) the user-associated-objects category, (ii) the user-unassociated-objects category, (iii) the positive-valence-objects category, and (iv) the negative-valence-objects category. The particular stimulus that is indicated in accordance with a particular testing arrangement is discussed further below with respect to block 306.

Note that the indication of the stimulus may be at least one of a visual stimulus, an auditory stimulus, and a tactile stimulus. In the case of a visual stimulus, the computing system may display, on graphical display 502, the stimulus (e.g., stimulus 402). In the case of an auditory stimulus, the computing system may play, perhaps via a speaker communicatively coupled to the computing system, an audible representation of the stimulus such as the word “fun” if the stimulus is the positive-valence object “fun.” In the case of seeing and/or hearing-impaired test subjects, the stimulus may be a tactile stimulus. For instance, the tactile stimulus may be a physical object that is readily identifiable (such as a cube, or sphere), or another tactile stimulus such as braille.

c. Receive Input Data Indicating Association of Stimulus With Group

At block 306, the computing system receives input data indicating a correct classification of the stimulus with one of the first group and the second group. That is, the test subject may depress one of buttons 520A and/or 520B to cause stimulus 406 to be correctly classified. In the case of the test arrangement shown in FIG. 5A, such a correct classification would occur upon the test subject depressing button 520B (as indicated by right hand 522B “pressing” 522B and left hand 522A not “pressing” button 520A).

A number of different combinations of categories, groups, and stimuli may exist and therefore the correct classification of the stimulus may vary. More particularly, as noted above, an IAT may involve at least two blocks, each block in turn involving a number of stimulus-presentation/test-subject-response pairs (or tasks). The categories and/or groups may vary from block-to-block, and the stimuli may vary from task-to-task, of a given test.

For example, as shown in FIG. 5A, the first group 510 may be the user-associated-objects category 512 and the positive-valence-objects category 514, the second group 504 may be the user-unassociated-objects category 506 and the negative-valence-objects category 508, the stimulus 406A may be an object from the user-associated-objects category 512, and the input data may indicate a correct classification of the stimulus with the first group 510 (e.g., as a result of depression of button 520B by the test subject).

As another example, as shown in FIG. 5B, the first group 510 may be the user-associated-objects category 512 and the negative-valence-objects category 514, the second group 504 may be the user-unassociated-objects category 506 and the positive-valence-objects category 508, the stimulus 406A may be an object from the user-associated-objects category 512, and the input data may indicate a correct classification of the stimulus with the first group 510 (e.g., as a result of depression of button 520B by the test subject).

With respect to both FIGS. 5A and 5B, button 520B is the correct response because stimulus 406A was flag 406 from user-associated-objects category 512 in first group 510. Note that a test subject with high self-esteem (i.e., I am “good”) should respond faster to the task presented in FIG. 5A than FIG. 5B.

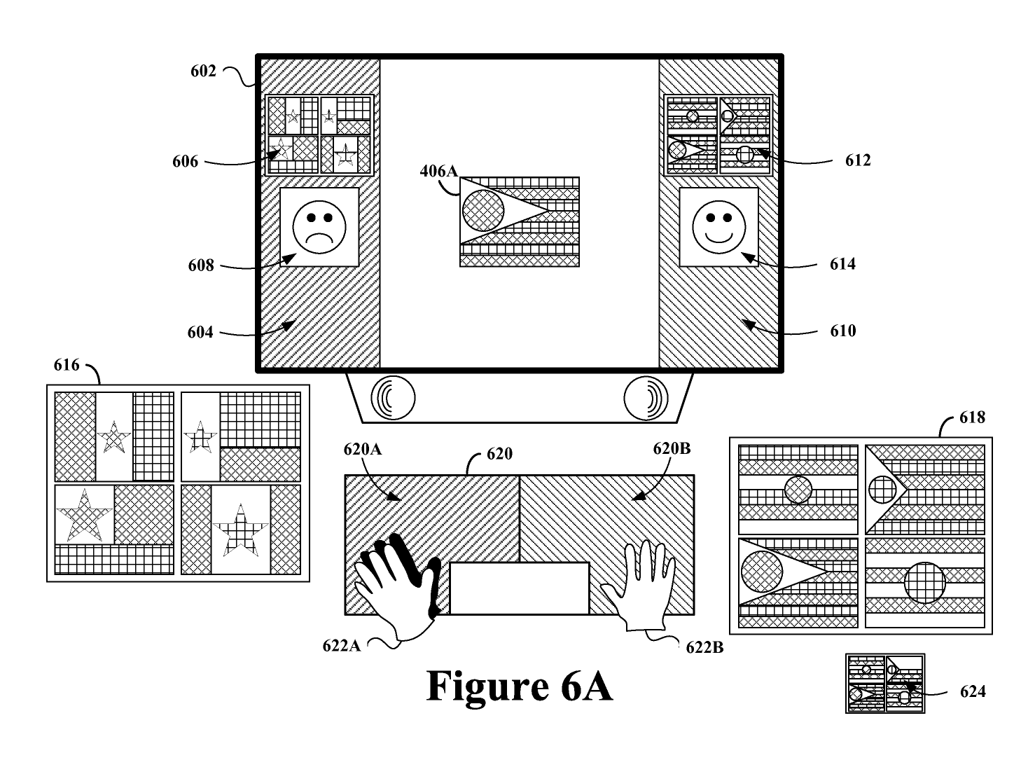

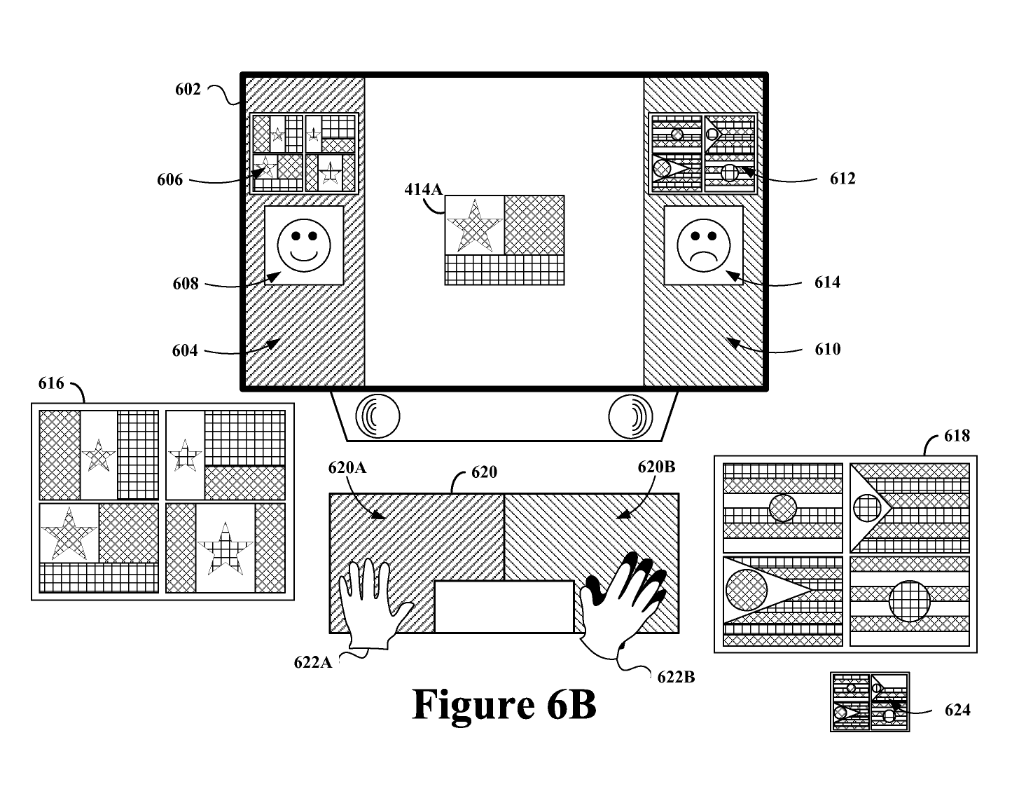

As another example, as shown in FIG. 6A, like in FIG. 5A, the first group 610 may be the user-associated-objects category 612 and the positive-valence-objects category 614, the second group 604 may be the user-unassociated-objects category 606 and the negative-valence-objects category 608, the stimulus 406A may be an object from the user-associated-objects category 612, and the input data may indicate a correct classification of the stimulus with the first group 610 (e.g., as a result of depression of button 620B by the test subject).

As another example, as shown in FIG. 6B, the first group 610 may be the user-associated-objects category 612 and the negative-valence-objects category 614, the second group 604 may be the user-unassociated-objects category 606 and the positive-valence-objects category 608, the stimulus 414A may be an object from the user-unassociated-objects category 606, and the input data may indicate a correct classification of the stimulus 414A with the second group 604 (e.g., as a result of depression of button 620A by the test subject).

With respect to FIG. 6A, the correct response was button 620B because stimulus 406A was flag 406 from user-associated-objects category 612 in first group 610. However, with respect to FIG. 6B, the correct response was button 620A because stimulus 414A was flag 414 from user-unassociated-objects category 606 in second group 604. Note that a test subject with high self-esteem (i.e., I am “good”) should respond faster to the task presented in FIG. 6A than FIG. 6B.

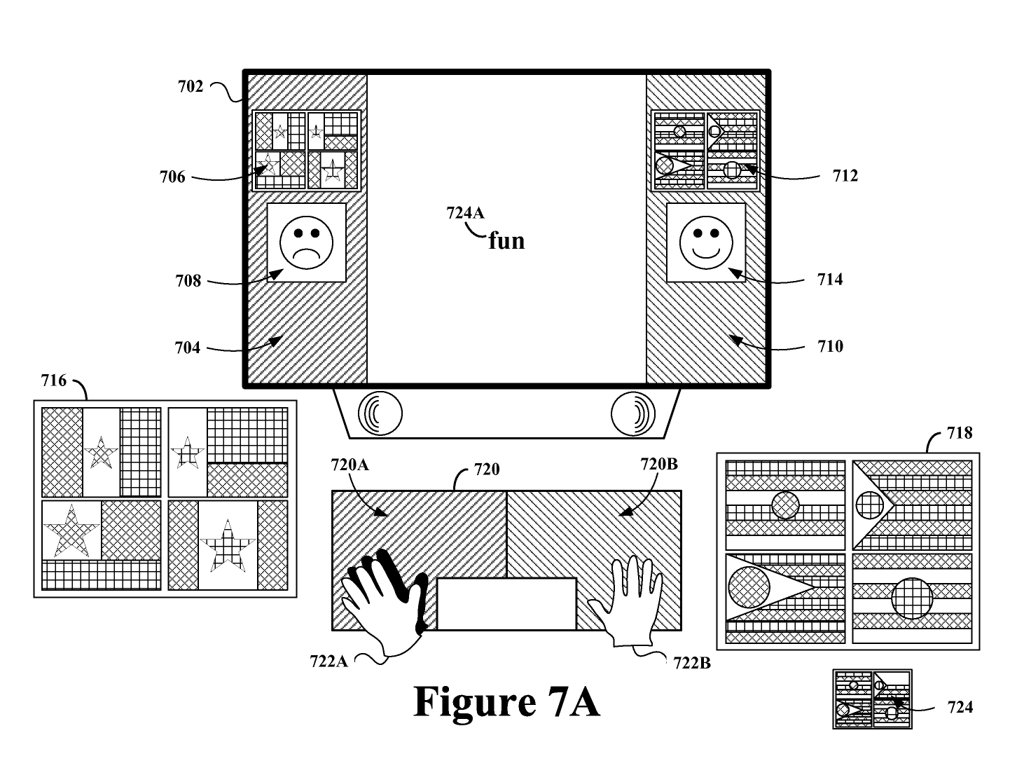

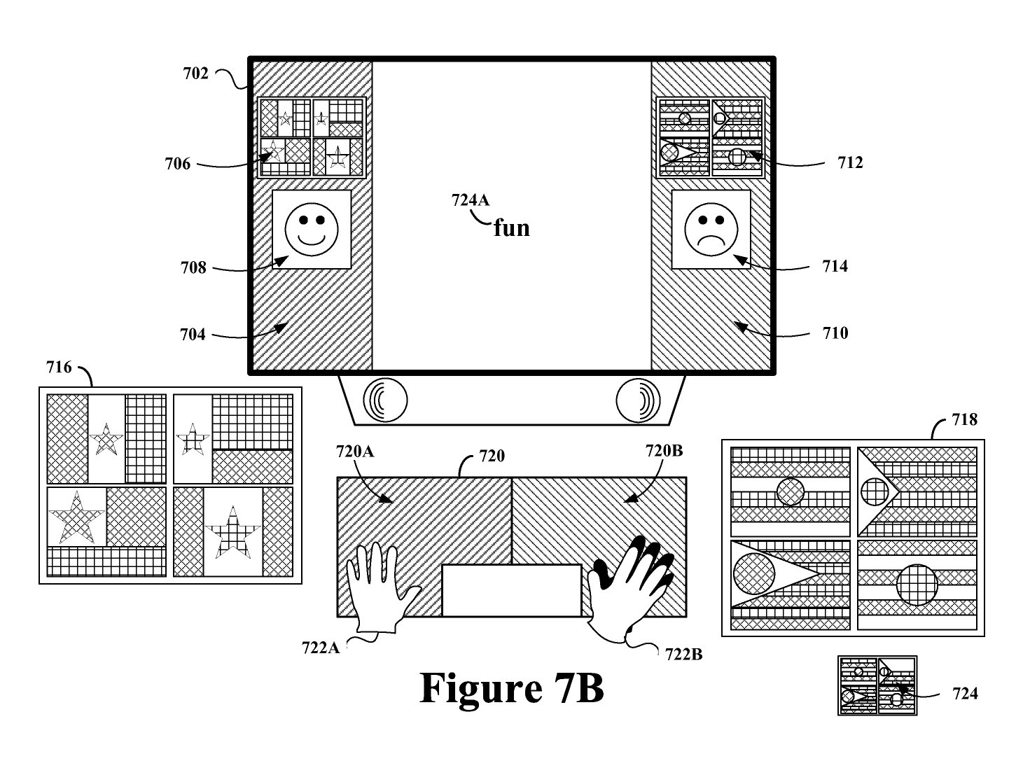

As another example, as shown in FIG. 7A, the first group 710 may be the user-associated-objects category 712 and the positive-valence-objects category 714, the second group 704 may be the user-unassociated-objects category 706 and the negative-valence-objects category 708, the stimulus 724 may be an object from the positive-valence-objects category 714, and the input data indicates a correct classification of the stimulus 724A with the first group 710 (e.g., as a result of depression of button 720B by the test subject).

As another example, the first group 710 may be the user-associated-objects category 712 and the negative-valence-objects category 714, the second group 704 may be the user-unassociated-objects category 706 and the positive-valence-objects category 708, the stimulus 724A may be an object from the positive-valence-objects category 708, and the input data may indicate a correct classification of the stimulus 724A with the second group 704 (e.g., as a result of depression of button 720B by the test subject).

With respect to FIG. 7A, the correct response was button 720B because stimulus 724A was word “fun” from positive-valence-objects category 714 in first group 710. However, with respect to FIG. 7B, the correct response was button 720A because stimulus 724A was word “fun” from positive-valence-objects category 708 in second group 704. Note that a test subject with high self-esteem (i.e., I am “good”) should respond faster to the task presented in FIG. 7A than FIG. 7B.

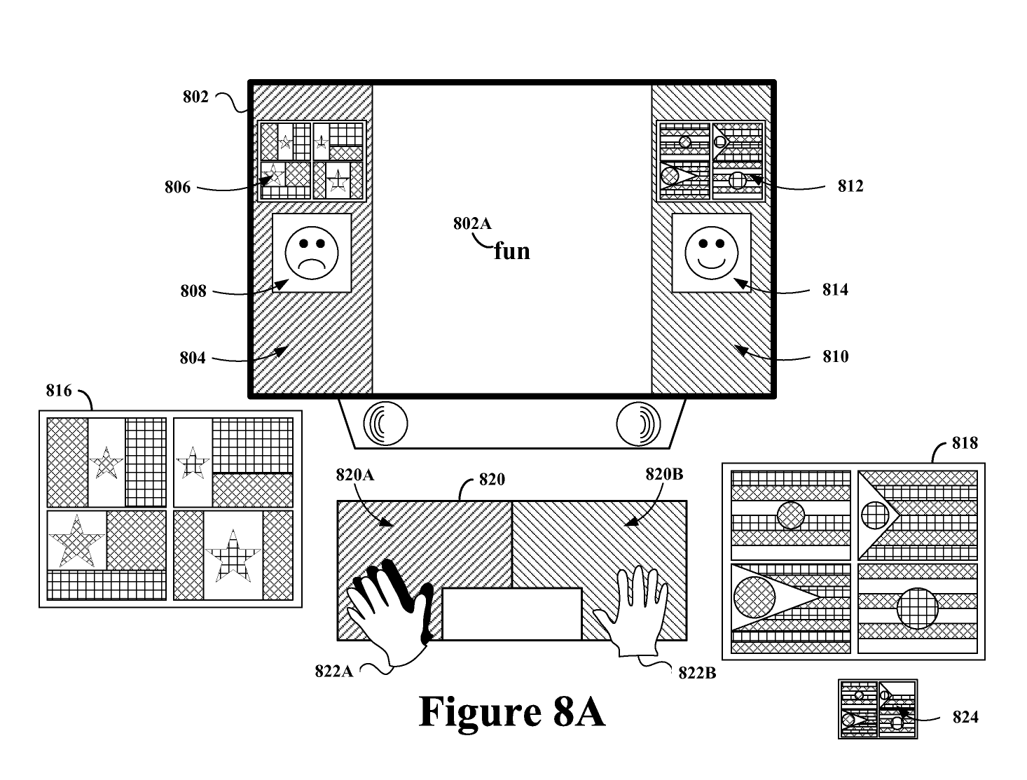

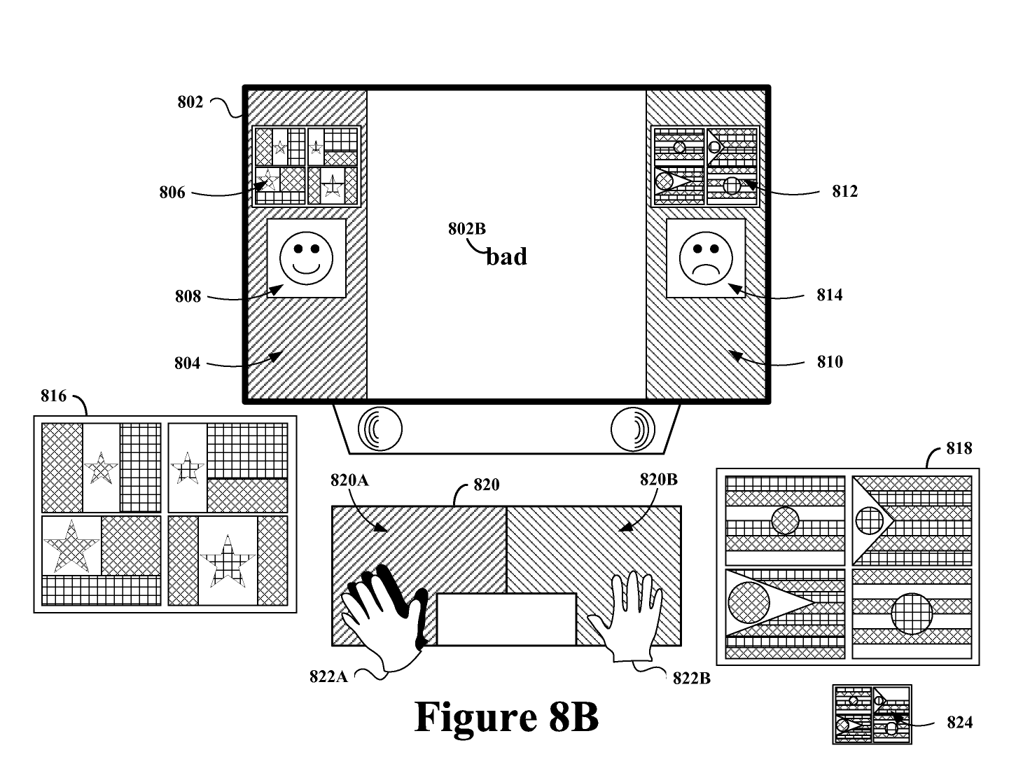

As another example, as shown in FIG. 8A, like FIG. 7A, the first group 810 may be the user-associated-objects category 812 and the positive-valence-objects category 814, the second group 804 may be the user-unassociated-objects category 806 and the negative-valence-objects category 808, the stimulus 808A may be an object from the positive-valence-objects category 814, and the input data may indicate a correct classification of the stimulus 802A with the first group 810 (e.g., as a result of depression of button 820B by the test subject).

As another example, as shown in FIG. 8B, the first group 810 may be the user-associated-objects category 812 and the negative-valence-objects category 814, the second group may be the user-unassociated-objects category 806 and the positive-valence-objects category 808, the stimulus 802B may be an object from the negative-valence-objects category 814, and the input data may indicate a correct classification of the stimulus 802B with the first group 810 (e.g., as a result of depression of button 820B by the test subject).

With respect to FIG. 8A, the correct response was button 820B because stimulus 802A was word “fun” from positive-valence-objects category 814 in first group 810. And, with respect to FIG. 8B, the correct response was button 820B because stimulus 802B was word “bad” from negative-valence-objects category 814 in first group 810. Note that a test subject with high self-esteem (i.e., I am “good”) should respond faster to the task presented in FIG. 8A than FIG. 8B.

d. Determine Amount of Time Between Providing Visual Indication of Stimulus and Receiving Input Data

At block 308, the computing system determines an amount of time elapsed between providing the indication of the stimulus and receiving the input data indicating the correct classification of the stimulus with one of the first group and the second group. As noted above, response times, or response latencies, in differing blocks may be used to implicitly assess a subject's degree of associations between categories. Thus, response latency for each task may be determined for each task in accordance with block 308. The computing system may determine the amount of time elapsed based on a computing-system clock and various related operating-system functions.

After determining the amount of time elapsed between providing the indication of the stimulus and receiving the input data indicating the correct classification of the stimulus with one of the first group and the second group, the computing system may provide an indication of positive feedback. In an embodiment, such positive feedback may take the form a cartoon animal that is smiling and giving a “thumbs up.” Such positive feedback may reinforce the test subject's interest in the test, and encourage the test subject to continue to place maximum effort into the forthcoming tasks. Accordingly, such positive feedback may be provided independent of, for example, the determined amount of time elapsed.

Additionally, after determining the amount of time elapsed between providing the indication of the stimulus and receiving the input data indicating the correct classification of the stimulus with one of the first group and the second group, the computing system may provide at least one of instructive feedback, where the instructive feedback includes information already provided to a user and corrective feedback, where the corrective feedback includes information instructing a user to modify a future action. The instructive feedback may include, for example, any information and/or instruction given to the test subject prior to beginning testing. Such instructive feedback may be provided on a random basis (so as to provide random reminders of desired instructions), or in response to particular actions of the test subject. Corrective feedback, may include, for example, any information and/or instruction given to the test subject in response to a particular action of the test subject, based on the recognition that the test subject has taken an undesired action. Examples of instructive feedback and corrective feedback are discussed further below.

Before receiving input data indicating a correct classification of the stimulus with one of the first group and the second group, the computing system may receive input data indicating an incorrect classification of the stimulus with one of the first group and the second group. In response, the computing system may provide an indication that the input data indicating an incorrect classification of the stimulus with one of the first group and the second group was received. In other words, the test subject may incorrectly classify the stimulus, and the computing system may indicate to the user that the classification was incorrect. Ultimately, the test subject may then be prompted to correctly classify the stimulus. The indication that the test subject incorrectly classified the stimulus is an example of “corrective feedback” as discussed above.

Further, the computing system may determine that the amount of time elapsed between providing the indication of the stimulus and receiving the input data indicating the correct classification of the stimulus with one of the first group and the second group exceeds a predetermined time threshold. In response, the computing system may provide an indication that stimuli should be correctly classified faster. For example, the test subject may be reminded to classify stimuli as quickly as possible. Such a reminder is an example of “instructive feedback” as discussed above.

More generally, “instructive feedback” may be implemented to ensure that the test subject has an understanding of the testing arrangement, particularly if changes to the testing arrangement have been made. For example, when moving from one testing block to another testing block, the categories associated with each group (i.e., the categories displayed on the left side of the screen and/or the right side of the screen) may change. Instructive feedback may be implemented to call attention to which categories are displayed at which respective location, and ensure that the user recognizes, understands, and/or comprehends the location of each category.

e. Additional Functions

The computing system may be configured to carry out various functions in addition to those functions described with respect to FIG. 3. As described above, generally, an IAT may involve at least two blocks, each block in turn involving a number of stimulus-presentation/test-subject-response pairs, or tasks. During the first block, the group/response-button combinations remain constant. Then, the relationship between the buttons and the groups and/or categories presented to the subject may be changed.

Accordingly, in practice, method 300 may be carried out a number of times (corresponding to individual tasks of a given block) throughout the duration of a block, where the relationship between the buttons and the groups and/or categories presented to the subject may remain constant. Then, method 300 may be carried out a number of times (corresponding to individual tasks of another given block) throughout the duration of another block, where the relationship between the buttons and the groups and/or categories presented to the subject may remain constant, though different from the previous block. Variations in latency-response times for the classification in stimuli for each block may be used to assess the test subject's implicit associations. Such an assessment may be referred to as a “self-esteem metric.”

Below, a number of relationships between the buttons and the groups and/or categories corresponding to a task from a first block, as well as relationships between the buttons and the groups and/or categories corresponding to a task from a second block are described. For each block combination, it is also described how the response times of the first block and the second block may be compared. Such a comparison may ultimately be used to implicitly assess a subject's degree of associations between categories.

During a task of a first block, the provided visual indication of the categories may be a first visual indication of the categories, the provided indication of the stimulus may be an indication of a first stimulus, the received input data may be first received input data, and the determination of the amount of time may be a determination of a first amount of time. Further, the first group may be the user-associated-objects category and the positive-valence-objects category, the second group may be the user-unassociated-objects category and the negative-valence-objects category, the first stimulus may be an object from the user-associated-objects category, and the first input data may indicate a correct classification of the first stimulus with the first group.

Then, during a task of a second block, the computing system may provide a second visual indication of categories including the user-associated-objects category, the user-unassociated-objects category, the positive-valence-objects category, and the negative-valence-objects category. The categories may be grouped into a third group and a fourth group, where the third group may be the user-associated-objects category and the negative-valence-objects category, and the fourth group may be the user-unassociated-objects category and the positive-valence-objects category. Then, the computing system may provide an indication of a second stimulus, where the second stimulus may be an object from the user-associated-objects category. Then, the computing system may receive second input data indicating a correct classification of the second stimulus with the third group. And the computing system may determine a second amount of time elapsed between providing the indication of the second stimulus and receiving the second input data indicating a correct classification of the second stimulus with the third group, compare the first amount of time to the second amount of time, and ultimately determine a self-esteem metric based on at least the comparison of the first amount of time to the second amount of time.

Comparing the first amount of time to the second amount of time may involve comparing an average of a plurality of response times (e.g., from multiple tasks within the first block), including the first amount of time, corresponding to receiving first input data indicating a correct classification of the stimulus that is an object from the user-associated-objects category with the first group to an average of a plurality of response times, including the second amount of time (e.g., from multiple tasks within the second block), corresponding to receiving second input data indicating a correct classification of a stimulus that is an object from the user-unassociated-objects category with the fourth group.

Alternatively, during a task of a first block, the provided visual indication of the categories may be a first visual indication of the categories, the provided indication of the stimulus may be an indication of a first stimulus, the received input data may be first received input data, and the determination of the amount of time may be a determination of a first amount of time. Further, the first group may be the user-associated-objects category and the positive-valence-objects category, the second group may be the user-unassociated-objects category and the negative-valence-objects category, the first stimulus may be an object from the user-associated-objects category, and the first input data may indicated a correct classification of the first stimulus with the first group.

Then, during a task of a second block, the computing system may provide a second visual indication of categories including the user-associated-objects category the user-unassociated-objects category, the positive-valence-objects category, and the negative-valence-objects category. The categories may be grouped into a third group and a fourth group, where the third group is the user-associated-objects category and the negative-valence-objects category, and the fourth group is the user-unassociated-objects category and the positive-valence-objects category. Then, the computing system may provide an indication of a second stimulus, where the second stimulus is an object from the user-unassociated-objects category. Then, the computing system may receive second input data indicating a correct classification of the second stimulus with the fourth group. And the computing system may determine a second amount of time elapsed between providing the indication of the second stimulus and receiving the second input data indicating a correct classification of the second stimulus with the fourth group, compare the first amount of time to the second amount of time, and determine a self-esteem metric based on at least the comparison of the first amount of time to the second amount of time.

Alternatively, during a task of a first block, the provided visual indication of the categories may be a first visual indication of the categories, the provided indication of the stimulus may be an indication of a first stimulus, the received input data is first received input data, and the determination of the amount of time may be a determination of a first amount of time. Further, the first group may be the user-associated-objects category and the positive-valence-objects category, the second group may be the user-unassociated-objects category and the negative-valence-objects category, the first stimulus may be an object from the positive-valence-objects category, and the first input data may indicate a correct classification of the first stimulus with the first group.

Then, during a task of a second block, the computing system may provide a second visual indication of categories including the user-associated-objects category, the user-unassociated-objects category, the positive-valence-objects category, and the negative-valence-objects category. The categories may be grouped into a third group and a fourth group, where the third group may be the user-associated-objects category and the negative-valence-objects category, and the fourth group is the user-unassociated-objects category and the positive-valence-objects category. Then, the computing system may provide an indication of a second stimulus, where the second stimulus may be an object from the positive-valence-objects category. Then, the computing system may receive second input data indicating a correct classification of the second stimulus with the third group. And the computing system may determine a second amount of time elapsed between providing the indication of the second stimulus and receiving the second input data indicating a correct classification of the second stimulus with the third group, compare the first amount of time to the second amount of time, and determine a self-esteem metric based on at least the comparison of the first amount of time to the second amount of time.

Alternatively, during a task of a first block, the provided visual indication of the categories may be a first visual indication of the categories, the provided indication of the stimulus may be an indication of a first stimulus, the received input data may be first received input data, and the determination of the amount of time may be a determination of a first amount of time. Further, the first group may be the user-associated-objects category and the positive-valence-objects category, the second group may be the user-unassociated-objects category and the negative-valence-objects category, the first stimulus may be an object from the positive-valence-objects category, and the first input data may indicate a correct classification of the first stimulus with the first group.

Then, during a task of the second block, the computing system may provide a second visual indication of categories including the user-associated-objects category, the user-unassociated-objects category, the positive-valence-objects category, and the negative-valence-objects category. The categories may be grouped into a third group and a fourth group, where the third group is the user-associated-objects category and the negative-valence-objects category, and the second group is the user-unassociated-objects category and the positive-valence-objects category. Then, the computing system may provide an indication of a second stimulus, where the second stimulus is an object from the negative-valence-objects category. Then, the computing system may receive second input data indicating a correct classification of the second stimulus with the third group. And the computing system may determine a second amount of time elapsed between providing the indication of the second stimulus and receiving the second input data indicating a correct classification of the second stimulus with the third group, compare the first amount of time to the second amount of time, and determine a self-esteem metric based on at least the comparison of the first amount of time to the second amount of time.

### 4. ADDITIONAL EMBODIMENTS

a. Modified Paper and Pencil IAT

In some situations, such as large-scale-testing situations, paper and pencil IATs may be administered to test subjects. Such a paper and pencil IAT may involve presenting the test subject with two pages, where each page contains two columns of some number of items, and concepts are printed on the top of a column. In each column, stimuli may appear in a different random order.

Test subjects may be given some fixed amount of time to classify as many items as possible without skipping items or correcting mistakes. For example, the test subject may fill in a bubble next to an item. As one particular example, test subjects may fill in bubbles on the left side for stimuli belonging to me or good categories, and would fill in bubbles on the right side for stimuli belonging to not-me or bad categories.

To assess the test subject's associations, difference scores may be obtained by subtracting the number of items correctly classified on one page from the items correctly classified on the other page. However, such a paper and pencil IAT may not be suitable for use with individuals possessing low cognitive development, such as young children. Thus, the paper and pencil IAT must be modified for use with such individuals.

One such modification may involve, instead of word lists, use of pictures representing categories of me (e.g., pictures of “my flags” as described above), not-me (e.g., pictures of “not my flags” as described above), good (e.g., positive-valence pictures), and bad (e.g., negative-valence pictures). In this way, the test subject need not necessarily be capable of cognitively understanding the concept of “self.”

Another modification may involve the concept on the top of each column being presented as pictures (e.g., collages of all items belonging to the relevant category).

Yet another modification may involve simplifying the procedure for classifying items. For instance, the test subject may circle words, color pictures, or check off words and/or pictures, among other examples.

Yet another modification still may involve a scoring algorithm that makes use of both individual error rates as well as the response times. For example, rather than being given a fixed amount of time, test subjects may be timed on how long it takes them to complete a list. In this way, by taking into account both the test subject's complete response time and error rate, a standardized score for each test subject may be calculated.

b. Card-Sort IAT

As one alternative to a paper and pencil IAT, and as a further modification to existing IATs, a card-sorting IAT may be administered. According to the card-sorting IAT, a test subject may be given a deck of cards containing pictures corresponding to me (e.g., pictures of “my flags” as described above), not-me (e.g., pictures of “not my flags” as described above), good (e.g., positive-valence pictures), and bad (e.g., negative-valence pictures). Two trays may then be placed to the left and to the right of the test subject, respectively. Inside each tray may be an indication of two categories. For example, an object (e.g., a card, sticker, token, etc.) representing my flags and good words may be placed in one tray, and objects representing not-my flags and bad words may be placed in the other tray.

The test subject's task may then be to sort all of the cards into the two trays as quickly as possible, without correcting mistakes. The overall time the test subject takes to complete the task may be monitored, or the number of mistakes made, or some combination of the two.

Then, the test subject may be given two new trays and a new deck of cards. In the new trays, a sticker representing my flags and bad words may be placed in one tray, and stickers representing not-my flags and good words may be placed in the other tray. The test subject's task may then be to sort all of the cards into the two new trays as quickly as possible, without correcting mistakes. The overall time the test subject takes to complete the task may be monitored.

Similar to the pencil and paper IAT, a scoring algorithm that makes use of both individual error rates as well as overall response times may be implemented. In this way, by taking into account both the test subject's complete response time and error rate, a standardized score for each test subject may be calculated.

c. Eye Tracking

As discussed above with respect to FIG. 300, the computing system may determine an amount of time elapsed between providing the indication of the stimulus and receiving the input data indicating the correct classification of the stimulus with one of the first group and the second group. Doing so may ultimately enable the computing system to determine a self-esteem metric based on at least the comparison of a first amount of time to a second amount of time.

In an alternative embodiment, eye-tracking hardware and/or software may be used in addition to, or instead of, timing techniques, to assess a test subject's associations. For example, when performing a classification of a stimuli, the computing system may track the degree-of-movement (e.g., total movement, average movement, etc.) of the test subject's eyes between being provided an indication of a stimulus and correctly classifying the stimulus. Generally, a higher degree-of-movement of the test subject's eyes may be associated with a higher degree of uncertainty, hesitation, or conscious thought required to classify the stimulus. For instance, when the test subject is uncertain of a classification, the test subject may glance to one or more representations of categories of objects to verify the correct classification.

Like the comparison of response latencies described above, a comparison of degree-of-movement of a user's eyes may be used to determine a self-esteem metric based on the comparison of a first degree-of-movement of a users' eyes and a second degree-of-movement of a user's eyes.

### 5. CONCLUSION

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A system comprising:
a processor;
a physical computer readable medium; and
program instructions stored on the physical computer readable medium and executable by the processor to:
provide a visual indication of categories including (i) a user-associated-objects category (ii) a user-unassociated-objects category, (iii) a positive-valence-objects category, and (iv) a negative-valence-objects category, wherein the categories are grouped into a first group and a second group, wherein the first group is one of (i) the user-associated-objects category and the positive-valence-objects category and (ii) the user-associated-objects category and the negative-valence-objects category, and wherein the second group is one of (i) the user-unassociated-objects category and the positive-valence-objects category, and (ii) the user-unassociated-objects category and the negative-valence-objects category;
provide an indication of a stimulus, the stimulus associated with at least one of (i) the user-associated-objects category, (ii) the user-unassociated-objects category, (iii) the positive-valence-objects category, and (iv) the negative-valence-objects category;
receive input data indicating a correct classification of the stimulus with one of the first group and the second group; and
determine an amount of time elapsed between providing the indication of the stimulus and receiving the input data indicating the correct classification of the stimulus with one of the first group and the second group.

2. The system of claim 1, wherein (a) the first group is the user-associated-objects category and the positive-valence-objects category, (b) the second group is the user-unassociated-objects category and the negative-valence-objects category, (c) the stimulus is an object from the user-associated-objects category or the positive-valence-objects category, and (d) the input data indicates a correct classification of the stimulus with the first group.

3. The system of claim 1, wherein (a) the first group is the user-associated-objects category and the negative-valence-objects category, (b) the second group is the user-unassociated-objects category and the positive-valence-objects category, (c) the stimulus is an object from the user-associated-objects category or the negative-valence-objects category, and (d) the input data indicates a correct classification of the stimulus with the first group.

4. The system of claim 1, wherein (a) the first group is the user-associated-objects category and the negative-valence-objects category, (b) the second group is the user-unassociated-objects category and the positive-valence-objects category, (c) the stimulus is an object from the user-unassociated-objects category or the positive-valence-objects category, and (d) the input data indicates a correct classification of the stimulus with the second group.

5. The system of claim 1, wherein (a) the first group is the user-associated-objects category and the positive-valence-objects category, (b) the second group is the user-unassociated-objects category and the negative-valence-objects category, (c) the stimulus is an object from the user-unassociated-objects category or the negative-valence-objects category, and (d) the input data indicates a correct classification of the stimulus with the second group.

6. The system of claim 1, wherein objects in the user-associated-objects category and the user-unassociated-objects category are substantially novel objects.

7. The system of claim 6, wherein the substantially novel objects are substantially gender-neutral objects.

8. The system of claim 6, wherein the substantially novel objects are substantially race-neutral objects.

9. The system of claim 1, wherein objects in the user-associated-objects category and the user-unassociated-objects category are at least one of flags, cards, chips, tokens, emblems, and clothing.

10. The system of claim 1, wherein the objects are flags.

11. The system of claim 1, wherein (a) the provided visual indication of the categories is a first visual indication of the categories, (b) the provided indication of the stimulus is an indication of a first stimulus, (c) the received input data is first received input data, and (d) the determination of the amount of time is a determination of a first amount of time, and wherein (a) the first group is the user-associated-objects category and the positive-valence-objects category, (b) the second group is the user-unassociated-objects category and the negative-valence-objects category, (c) the first stimulus is an object from the user-associated-objects category or the positive-valence-objects category, and (d) the first input data indicates a correct classification of the first stimulus with the first group, the system further comprising program instructions stored on the physical computer readable medium and executable by the processor to:
provide a second visual indication of categories including (i) the user-associated-objects category, (ii) the user-unassociated-objects category, (iii) the positive-valence-objects category, and (iv) the negative-valence-objects category, wherein the categories are grouped into a third group and a fourth group, wherein (i) the third group is the user-associated-objects category and the negative-valence-objects category, and (ii) the fourth group is the user-unassociated-objects category and the positive-valence-objects category;
provide an indication of a second stimulus, wherein the second stimulus is an object from the user-associated-objects category or the negative-valence-objects category;
receive second input data indicating a correct classification of the second stimulus with the third group;
determine a second amount of time elapsed between providing the indication of the second stimulus and receiving the second input data indicating a correct classification of the second stimulus with the third group;
compare the first amount of time to the second amount of time; and
determine a self-esteem metric based on at least the comparison of the first amount of time to the second amount of time.

12. The system of claim 1, wherein (a) the provided visual indication of the categories is a first visual indication of the categories, (b) the provided indication of the stimulus is an indication of a first stimulus, (c) the received input data is first received input data, and (d) the determination of the amount of time is a determination of a first amount of time, and wherein (a) the first group is the user-associated-objects category and the positive-valence-objects category, (b) the second group is the user-unassociated-objects category and the negative-valence-objects category, (c) the first stimulus is an object from the user-associated-objects category or the positive-valence objects category, and (d) the first input data indicates a correct classification of the first stimulus with the first group, the system further comprising program instructions stored on the physical computer readable medium and executable by the processor to:
provide a second visual indication of categories including (i) the user-associated-objects category, (ii) the user-unassociated-objects category, (iii) the positive-valence-objects category, and (iv) the negative-valence-objects category, wherein the categories are grouped into a third group and a fourth group, wherein (i) the third group is the user-associated-objects category and the negative-valence-objects category, and (ii) the fourth group is the user-unassociated-objects category and the positive-valence-objects category;
provide an indication of a second stimulus, wherein the second stimulus is an object from the user-unassociated-objects category or the positive-valence-objects category;
receive second input data indicating a correct classification of the second stimulus with the fourth group;
determine a second amount of time elapsed between providing the indication of the second stimulus and receiving the second input data indicating a correct classification of the second stimulus with the fourth group;
compare the first amount of time to the second amount of time; and
determine a self-esteem metric based on at least the comparison of the first amount of time to the second amount of time.

13. The system of claim 1, wherein (a) the provided visual indication of the categories is a first visual indication of the categories, (b) the provided indication of the stimulus is an indication of a first stimulus, (c) the received input data is first received input data, and (d) the determination of the amount of time is a determination of a first amount of time, and wherein (a) the first group is the user-associated-objects category and the positive-valence-objects category, (b) the second group is the user-unassociated-objects category and the negative-valence-objects category, (c) the first stimulus is an object from the user-associated-objects category or the positive-valence-objects category, and (d) the first input data indicates a correct classification of the first stimulus with the first group, the system further comprising program instructions stored on the physical computer readable medium and executable by the processor to:
provide a second visual indication of categories including (i) the user-associated-objects category, (ii) the user-unassociated-objects category, (iii) the positive-valence-objects category, and (iv) the negative-valence-objects category, wherein the categories are grouped into a third group and a fourth group, wherein (i) the third group is the user-associated-objects category and the negative-valence-objects category, and (ii) the fourth group is the user-unassociated-objects category and the positive-valence-objects category;
provide an indication of a second stimulus, wherein the second stimulus is an object from the positive-valence-objects category or the user-associated objects category;
receive second input data indicating a correct classification of the second stimulus with the third group;
determine a second amount of time elapsed between providing the indication of the second stimulus and receiving the second input data indicating a correct classification of the second stimulus with the third group;
compare the first amount of time to the second amount of time; and
determine a self-esteem metric based on at least the comparison of the first amount of time to the second amount of time.

14. The system of claim 1, wherein (a) the provided visual indication of the categories is a first visual indication of the categories, (b) the provided indication of the stimulus is an indication of a first stimulus, (c) the received input data is first received input data, and (d) the determination of the amount of time is a determination of a first amount of time, and wherein (a) the first group is the user-associated-objects category and the positive-valence-objects category, (b) the second group is the user-unassociated-objects category and the negative-valence-objects category, (c) the first stimulus is an object from the user-associated-objects category or the positive-valence objects category, and (d) the first input data indicates a correct classification of the first stimulus with the first group, the system further comprising program instructions stored on the physical computer readable medium and executable by the processor to:
provide a second visual indication of categories including (i) the user-associated-objects category, (ii) the user-unassociated-objects category, (iii) the positive-valence-objects category, and (iv) the negative-valence-objects category, wherein the categories are grouped into a third group and a fourth group, wherein (i) the third group is the user-associated-objects category and the positive-valence-objects category, and (ii) the fourth group is the user-unassociated-objects category and the negative-valence-objects category;
provide an indication of a second stimulus, wherein the second stimulus is an object from the user-unassociated-objects category or the negative-valence-objects category;
receive second input data indicating a correct classification of the second stimulus with the fourth group;
determine a second amount of time elapsed between providing the indication of the second stimulus and receiving the second input data indicating a correct classification of the second stimulus with the fourth group;
compare the first amount of time to the second amount of time; and
determine a self-esteem metric based on at least the comparison of the first amount of time to the second amount of time.

15. The system of claim 1, wherein the indication of the stimulus is at least one of a visual stimulus, an auditory stimulus, and a tactile stimulus.

16. The system of claim 1, the system further comprising program instructions stored on the physical computer readable medium and executable by the processor to:
after determining the amount of time elapsed between providing the indication of the stimulus and receiving the input data indicating the correct classification of the stimulus with one of the first group and the second group, provide an indication of positive feedback.

17. The system of claim 1, the system further comprising program instructions stored on the physical computer readable medium and executable by the processor to:
after determining the amount of time elapsed between providing the indication of the stimulus and receiving the input data indicating the correct classification of the stimulus with one of the first group and the second group, provide at least one of (i) instructive feedback, wherein the instructive feedback comprises information already provided to a user and (ii) corrective feedback, wherein the corrective feedback comprises information instructing a user to modify a future action.

18. The system of claim 1, the system further comprising program instructions stored on the physical computer readable medium and executable by the processor to:
before receiving input data indicating a correct classification of the stimulus with one of the first group and the second group, receiving input data indicating an incorrect classification of the stimulus with one of the first group and the second group; and
providing an indication that the input data indicating an incorrect classification of the stimulus with one of the first group and the second group was received.

19. The system of claim 1, the system further comprising program instructions stored on the physical computer readable medium and executable by the processor to:
determine that the amount of time elapsed between providing the indication of the stimulus and receiving the input data indicating the correct classification of the stimulus with one of the first group and the second group exceeds a predetermined time threshold; and
provide an indication that stimuli should be correctly classified faster.

20-27. (canceled)

28. A method comprising:
providing a visual indication of categories including (i) a user-associated-objects category (ii) a user-unassociated-objects category, (iii) a positive-valence-objects category, and (iv) a negative-valence-objects category, wherein the categories are grouped into a first group and a second group, wherein the first group is one of (i) the user-associated-objects category and the positive-valence-objects category and (ii) the user-associated-objects category and the negative-valence-objects category, and wherein the second group is one of (i) the user-unassociated-objects category and the positive-valence-objects category, and (ii) the user-unassociated-objects category and the negative-valence-objects category;
providing an indication of a stimulus, the stimulus associated with at least one of (i) the user-associated-objects category, (ii) the user-unassociated-objects category, (iii) the positive-valence-objects category, and (iv) the negative-valence-objects category;
receiving input data indicating a correct classification of the stimulus with one of the first group and the second group; and
determining an amount of time elapsed between providing the indication of the stimulus and receiving the input data indicating a correct classification of the stimulus with one of the first group and the second group.

29. The method of claim 28, wherein (a) the first group is the user-associated-objects category and the positive-valence-objects category, (b) the second group is the user-unassociated-objects category and the negative-valence-objects category, (c) the stimulus is an object from the user-associated-objects category or the positive-valence-objects category, and (d) the input data indicates a correct classification of the stimulus with the first group.

30. The method of claim 28, wherein (a) the first group is the user-associated-objects category and the negative-valence-objects category, (b) the second group is the user-unassociated-objects category and the positive-valence-objects category, (c) the stimulus is an object from the user-associated-objects category or the negative-valence-objects category, and (d) the input data indicates a correct classification of the stimulus with the first group.

31. The method of claim 28, wherein (a) the first group is the user-associated-objects category and the negative-valence-objects category, (b) the second group is the user-unassociated-objects category and the positive-valence-objects category, (c) the stimulus is an object from the user-unassociated-objects category, or the positive-valence-objects category and (d) the input data indicates a correct classification of the stimulus with the second group.

32. The method of claim 28, wherein (a) the first group is the user-associated-objects category and the positive-valence-objects category, (b) the second group is the user-unassociated-objects category and the negative-valence-objects category, (c) the stimulus is an object from the user-unassociated-objects category, or the negative-valence-objects category and (d) the input data indicates a correct classification of the stimulus with the second group.

33. The method of claim 28, wherein objects in the user-associated-objects category and the user-unassociated-objects category are substantially novel objects.

34. The method of claim 28, wherein objects in the user-associated-objects category and the user-unassociated-objects category are at least one of flags, cards, chips, tokens, emblems, and clothing.

35. The method of claim 30, wherein the objects are flags, and wherein the flags consist of three colors.
